(19) United States
(12) Patent Application Publication
(10) Pub. No.: US 2011/0084093 A1
(43) Pub. Date: Apr. 14, 2011

(54) UNIT-DOSE PACKAGE FOR DENTAL MIXING DEVICE

(75) Inventors: Klaus-Dieter NEHREN, Dormagen (DE); Andreas GRUNDLER, Dormagen (DE); Alf MEMMER, Ratingen (DE)

(73) Assignee: HERAEUS KULZER GMBH, Hanau (DE)

(21) Appl. No.: 12/901,670

(22) Filed: Oct. 11, 2010

(30) Foreign Application Priority Data
Oct. 13, 2009 (DE) 10 2009 049 285.2

(51) Int. Cl. B67D 7/70; B67D 7/78; B65D 88/54

(52) U.S. Cl. 222/137; 222/333; 222/145.6

(57) ABSTRACT

A dental mixing device (10) is provided for generating a multi-component material (11) by squeezing out and mixing the components of the multi-component material (11) from at least one first (20, 20′) and one second cartridge (30, 30′). The first cartridge (20, 20′) and the second cartridge (30, 30′) are arranged in the dental mixing device (10) such as to be replaceable. The mixing device has a first (21) and a second feed line (31) for guiding the components respectively from the first cartridge (20, 20′) and the second cartridge (30, 30′) into a mixer (40) and has a motorized advancer (50) for squeezing the components from the first (20, 20′) and the second cartridge (30, 30′). At least the first cartridge (20, 20′) is a unit-dose package and has a first volume between 20 ml and 60 ml.

### BACKGROUND OF THE INVENTION

The invention relates to a dental mixing device for generating a multi-component material by squeezing out and mixing the components of the multi-component material from at least one first and one second cartridge, wherein the first cartridge and the second cartridge are arranged in the dental mixing device such as to be replaceable, having a first and a second feed line for guiding the components from the first cartridge and the second cartridge into a mixer, and having a motorized advancer for squeezing the components from the first and the second cartridge.

The European patent application publication EP 1 010 401 A1 presents a dental mixing device for the production of curing dental multi-component impression materials. Components that are contained in cylindrical cartridges and are squeezed out synchronously, in the course of which they are mixed, are used for production of these multi-component materials. The cartridges are provided as reservoir cylinders which form, at their front end, a nozzle opening, each of which is attached to an inlet opening of a mixing nozzle and whose rear end is open to receive a plunger that is moved forward to squeeze out the material. For this purpose, use is made of a device, into which are inserted the cartridges that are attached or are to be attached to the mixing nozzle and which comprises, for each cartridge, a piston that acts through the open rear end of the cartridge on the plunger thereof. In order to attain a constant mixing ratio, the pistons are connected to each other mechanically for synchronous motion and are provided with a common electric drive. The drive contains a coupling that can be disengaged to allow the pistons to be retracted by hand from the cartridges when they are to be replaced. The replacement is effected when the cartridges are empty or when a different type of impression material is to be used. For the filling of impression trays, it is common to use devices that are provided with cartridges or tubular bags of a capacity up to 360 ml. These package sizes are usually sufficient for 10 tray fillings. It has proven to be disadvantageous in this context that the materials used for this purpose are set to a fixed mixing ratio of 5 parts base paste to 1 part catalyst paste, since the devices all comprise a common conveying advancement for both components.

### BRIEF SUMMARY OF THE INVENTION

It is the objective of the present invention to create a dental mixing device, in which the above-mentioned disadvantageous are circumvented, in particular in which the mixing ratio of the components of the multi-component material can be changed simply and easily.

In order to meet the objective, the invention proposes a dental mixing device of the type described at the outset, wherein the first cartridge is a unit-dose package and has a first volume between 20 ml and 60 ml.

The main rationale underlying the invention is that one component is present in the first cartridge only in quantities that are sufficient for one application. For this purpose, the first cartridge is designed as a unit-dose package. The unit-dose package generally is sufficient to fill a tray once. For this purpose, the first cartridge has a first volume between 20 ml and 60 ml, preferably a volume of 25 ml or 50 ml. This volume is selected suitably such that the quantity of the component contained therein is sufficient to completely fill an impression tray or impression half-tray with the impression material designed as multi-component material. Another special feature is that different first cartridges can be selected depending on the desired mixing ratio in the individual case. Accordingly, the first volume of the first cartridge is adapted to suit the mixing ratio. It is not intended to continue the use of the first cartridge once it has been emptied. Therefore, higher hygienic standards are attained, since partly spent cartridges do not remain in the dental mixing device.

Another advantageous embodiment of the dental mixing device according to the invention is characterized in that the second cartridge is a unit-dose package and, in particular, has a second volume between 5 ml and 30 ml. In this embodiment, both the first cartridge and the second cartridge are unit-dose packages that have a reduced volume as compared to the prior art. In an advantageous embodiment of this variant, the first cartridge stores a base component and the second cartridge stores an activator component. It is thus possible to supply a dentist with a first cartridge having a fixed volume. Only the volume of the second cartridge can be adapted to suit the desired mixing ratios. Accordingly, the dentist is supplied with a plurality of types of the second cartridge, which have volumes between 5 ml and 30 ml. By selecting the second volume of the second cartridge, the dentist can set the mixing ratio of base component and activator component of the multi-component material in a customized manner for each patient. This does not require any tedious, in particular laborious, adjustment of corresponding regulating features on the dental mixing device. Rather, it is sufficient for the dentist to select the corresponding unit-dose package of the second cartridge. This attains a higher hygienic standard.

In this embodiment, both requisite components, a base component and an activator component, are provided as unit-dose packages for single use. The consistency of the mixture is determined by the user by the selection of the unit dose-packed base component. The processing time is set either by the mixing ratio of activator component and base component or by the selection of differently reactive unit dose-packed activator components.

In an alternative variant of this embodiment, the second cartridge has a second volume between 100 ml and 500 ml. This is expedient especially if the first cartridge, as before, stores a base component and the second cartridge stores an activator component. In each case, the activator is added to the base component in order to generate a multi-component material. In order to render the conveying of the activator component to the base component variable, it may be advantageous for the second cartridge to have a second volume between 100 ml and 500 ml, such that it can be used for setting a multi-component material sufficient for an average of approx. 20-30 impression trays. The dosing ratio of base and activator component provides for individual control over the processing time in each case. Advantageously, the activator component can be used universally for all planned consistencies of the ready-mixed multi-component material. The base component is conveyed to the dental mixing device in the frame of the first cartridge as a unit-dose package. Subsequently, the activator component from the second cartridge is mixed in the mixer with the base component from the first cartridge in order to produce the multi-component material. In this variant of the embodiment, the quantity of activator component conveyed can be varied and/or the consistency of the multi-component material can be determined by the selection of the type of base component in the first cartridge.

The base components comprise, as main ingredients, cross-linkable monomers and/or pre-polymers, such as OH-terminated siloxanes, alkoxysilane-terminated polyethers, aziridine-terminated polyethers, allyl-terminated polyethers, vinyl-terminated polyethers, vinyl-terminated siloxanes, and/or SiH-terminated siloxanes. Moreover, base components may also comprise filling agents, flavoring agents, dyes, diluting agents, thickening agents, retarding agents or promoters. Aside from the matrix-forming filling agents, diluting agents, thickening agents, flavoring agents, and dyes, the activator components can also contain catalysts, cross-linkers and retarding agents or promoters.

The dental mixing device can be used for all chemically-curing multi-component products, such as impression materials, bite registration materials and duplicating materials based on condensation-crosslinking silicones, addition-crosslinking silicones, condensation-crosslinking silane-terminated polyethers, addition-crosslinking aziridine-terminated polyethers, and addition-crosslinking allyl-terminated polyethers.

The first cartridge and/or second cartridge according to the invention can be designed as a unit-dose package in the form of tubular film bags, side-sealed bags, blisters, cans, tubes, cartridges, sleeves or bottles. Glass, sheet steel, aluminum, paper, carton, and/or homopolymeric, copolymeric and/or coextruded plastic materials comprising, for example, PP, PE, PA, POM, PET, PBT, PTFE, EVOH, ABS, or PVC, can be used as materials of the first cartridge and/or second cartridge. To increase the mechanical stability, compatibility of the materials or barrier properties, the materials of the first cartridge and/or second cartridge can be multi-layered, coated, laminated, vapor-deposited, or filled. Common protective varnishes, waxes, pigments, fibers, mica, layered silicates, quartzes, metal oxide, or fluoropolymers can be used for this purpose.

Another advantageous embodiment of the dental system according to the invention is characterized in that the advancer comprises a first and/or a second plunger for squeezing the components from the first and/or the second cartridge. It has proven to be advantageous for the first cartridge and/or the second cartridge to be provided in the form of a sleeve. A first and/or second plunger each acts on the sleeve and, in the process, squeezes the components from the sleeve. Subsequently, the components can flow through a first and/or second feed line into the mixer where they are mixed with each other. Squeezing the sleeve-shaped cartridges out by the plunger(s) ensures that the quantities contained in the unit-dose package are squeezed out completely and with no residues. It is thereby ensured that the cartridges have to comprise just the needed quantities of the two components in each individual case. Thus, there remain no or only scarce residues in the squeezed-out first and/or second cartridge, which therefore cannot subsequently turn into a hygienic burden in a dental office.

An advantageous embodiment is characterized in that the advancer comprises at least one electrical motor. The electrical motor of the advancer provides for advancement of the plunger and/or a mixer drive. A correspondingly designed gear can provide for both the plungers and the mixer to be driven by an electrical motor. Thus, a particularly compact dental mixing device is attained, in which the advancer comprises but a single electrical motor. Alternatively, it is feasible for each plunger and/or the mixing device to be provided with an electrical motor, each of which allows for individual triggering in each case.

Another advantageous embodiment of the dental mixing device is characterized in that it comprises a magazine for a plurality of first cartridges. The magazine is integrated into the dental mixing device and stores a plurality, at least, of the first cartridge and, if applicable, of the second cartridge also. The magazine can be designed as a rod-shaped magazine, such that a plurality of first cartridges are arranged one behind the other in lying down position. The user of the dental mixing device according to the invention can use a lever or a door to convey a first cartridge from the magazine to the dental mixing device, such that it comes to rest in lying down position upstream of the mixer in order to be squeezed out. In addition, the dental mixing device can comprise two magazines, wherein one magazine is provided for the first cartridge and the other magazine is provided for the second cartridge.

Another advantageous embodiment of the dental device according to the invention is characterized in that the dental mixing device and/or the advancer comprises a computer unit for monitoring and/or controlling a squeezing out of the components from the first and/or the second cartridge. The computer unit serves to control and monitor the joining of the components of the multi-component material in order to ensure homogeneous production of the multi-component material. Expedient as a computer unit are, in particular, micro-controllers or FPGAs (field programmable gate arrays). Computer units of this type can be controlled by software and adapted individually to the respective wishes of a buyer of the dental mixing device. Moreover, computer units of this type are powerful, yet inexpensive.

Another advantageous embodiment of the dental mixing device is characterized in that the mixer is provided to be replaceable. The individual components are guided together and mixed with each other in the mixer in order to produce the multi-component material. In order to attain this goal, the mixer can comprise appropriate stirrers that ensure even and homogeneous mixing of the components. In order not to have possible residues cause hygienic problems after mixing a dose of the multi-component material, it has proven to be advantageous to provide the mixer so as to be replaceable. For this purpose, appropriate reversible detachable connectors can be provided that connect the mixer to the feed lines. The components from the two cartridges can flow into the mixer through the feed lines. Once the production of the multi-component material is completed, the mixer is unlocked on the non positive- or positive fit-type connector, such as quick-release fasteners, and can be either cleaned or discarded. In this context, the quick-release fasteners should act either clip-like or bayonet closure-like, in order to ensure the coupling of the mixer to the dental mixing device.

Another variant of this embodiment of the dental mixing device according to the invention is characterized in that the dental mixing device comprises a compression unit for compressing or ejecting the first cartridge and/or the second cartridge after squeezing it out. The first cartridge of the dental mixing device according to the invention is a unit-dose package. After use, the unit-dose package of the first cartridge can be ejected from the dental mixing device. In order to facilitate the ejection, the dental mixing device comprises a compression unit. The compression unit takes the cartridge from the storage site and ejects it from the dental mixing device. The compression unit can, in addition, also compress the cartridge. This leads to less waste, and the burden on the environment is reduced. Advantageously, after ejection of the first and/or second cartridge, the compression unit takes another cartridge from the magazine and inserts it into the corresponding storage site of the dental mixing device.

In order to check the operability of the dental mixing device and/or to track the mixing process of the multi-component material, the dental mixing device can comprise a display. The display can display information from the dental mixing device, in particular from the computer unit in an acoustic, visual or haptic manner. It has proven to be particularly advantageous for the display to be a touchscreen. A touchscreen enables bidirectional input and output of information into and from the dental mixing device.

Another advantageous embodiment of the dental mixing device according to the invention is characterized in that it comprises an interface to a central computer unit. The central computer unit can be connected to the dental mixing device and, for example, receive information about the number of first and/or second cartridges from the dental mixing device. Accordingly, central monitoring even of a plurality of dental mixing devices, for example in a dental office setting, is feasible.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic elevation view of a first embodiment of a dental mixing device according to the invention;

FIG. 2 is a schematic elevation view of another embodiment of a dental mixing device according to the invention; and

FIG. 3 is a schematic elevation view of a further embodiment of a dental mixing device according to the invention.

### DETAILED DESCRIPTION OF THE INVENTION

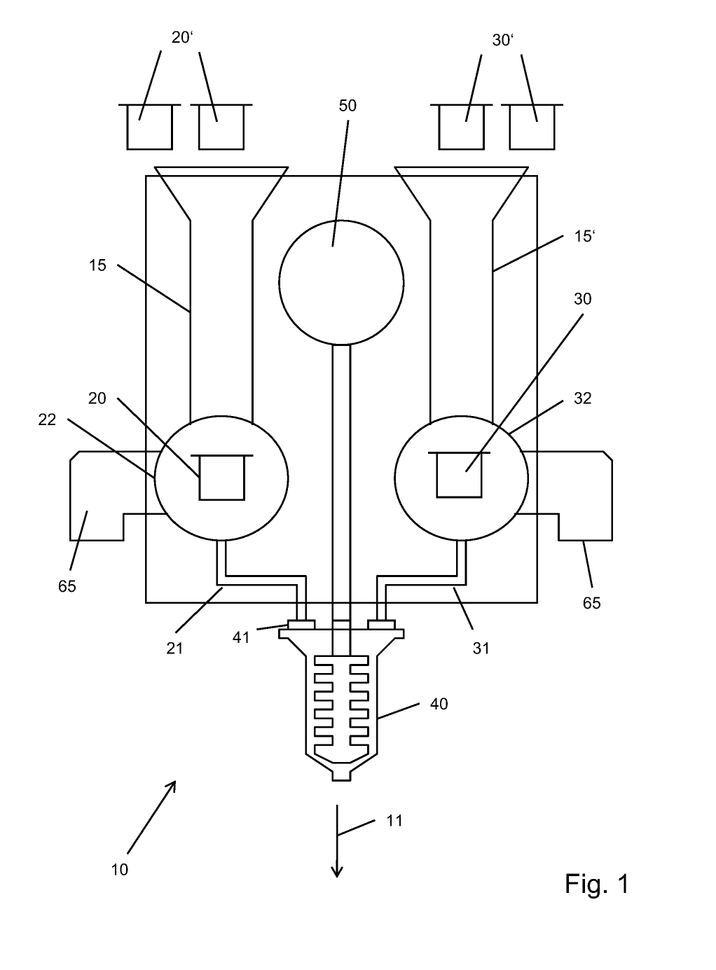

FIG. 1 shows a dental mixing device 10 according to the invention. The dental mixing device 10 serves for generating a multi-component material 11 for dental use. Dental multi-component materials 11 of this type are used by dentists as impression materials to be able to document tooth positions. In the process, the multi-component material 11 is mixed from at least two components which are each stored separately in a first cartridge 20, 20′ or a second cartridge 30, 30′. The first cartridge 20 and the second cartridge 30 containing the respective components are arranged in the dental mixing device 10 so as to be replaceable. A first feed line 21 leads from a first storage site 22 of the first cartridge 20 to a mixer 40. A second storage site 32, in which the second cartridge 30 is stored such as to be replaceable, is provided for the second cartridge 30. A second feed line 31 leads from the second storage site 32 to the mixer 40.

A motorized advancer 50 is provided in the dental mixing device 10 and serves for squeezing the components from the first cartridge 20 and the second cartridge 30. The components then flow via the first and the second feed lines 21, 31 into the mixer 40. The feed lines 21, 31 can be part of the first or second cartridge 20, 30, respectively. The two components are stirred inside the mixer 40, such that a multi-component material 11 is formed, which is as homogeneous as possible and flows out of a corresponding outlet.

In order to overcome the disadvantages mentioned above, the dental mixing device 10 according to embodiments of the invention is provided such that the first cartridge 20, 20′ is a unit-dose package and has a first volume between 20 ml and 60 ml. The first cartridge 20, 20′ is a unit-dose package such that the quantity of the component that is contained therein suffices for one application only. Accordingly, it is feasible to generate only the quantity of the multi-component material 11 that suffices for maximally one impression tray. In this context, the first cartridge 20, 20′ advantageously comprises a base component of the multi-component material. In the exemplary embodiment shown, the second cartridge 30, 30′ is also provided in the form of a unit-dose package and has a second volume between 5 ml and 30 ml.

This combination allows a user of the dental mixing device 10 according to the invention to pre-select the ratio of the two components of the multi-component material. In accordance with the desired mixing ratio, the user of the dental mixing device 10 selects a first cartridge 20, 20′ having a volume that the user needs for his later application. By selecting the second volume of the second cartridge 30 appropriately, the user of the dental mixing device 10 according to the invention defines the mixing ratio of the components of the multi-component material 11. Then, it is only necessary to insert the two cartridges 20, 30 into the dental mixing device 10 according to the invention in order to obtain the desired multi-component material 11.

The dental mixing device comprises a magazine 15 for storage of the first cartridge 20, 20′. A plurality of first cartridges 20′ can be stored in the magazine. Once a first cartridge 20′ has been squeezed out, the first cartridge 20′ can be ejected by manual or mechanical means and, correspondingly, another first cartridge 20′ can slip from the magazine 15 into the first storage site 22. The dental mixing device 10 comprises a second magazine 15′ for the second cartridges 30, 30′.

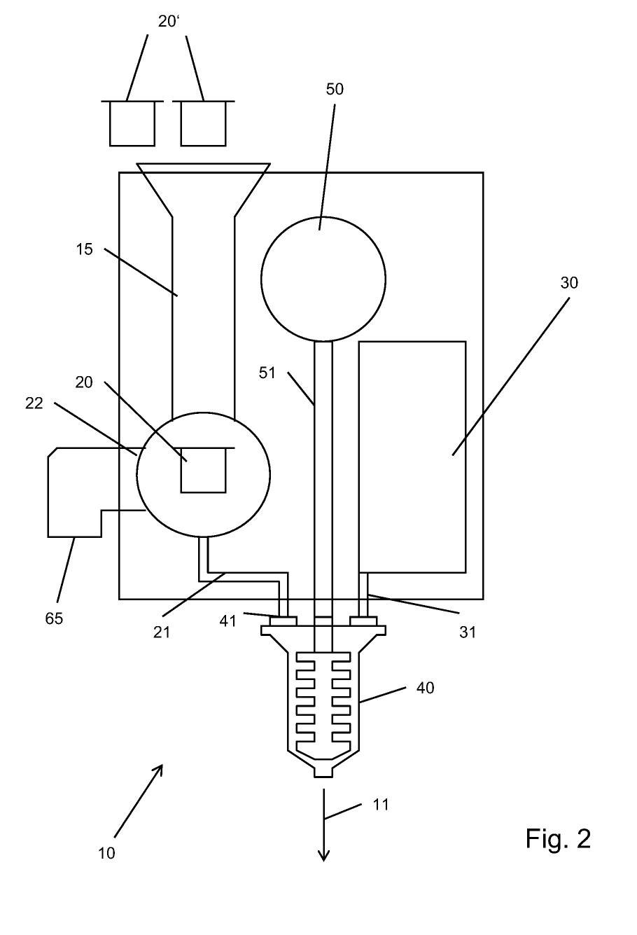

FIG. 2 shows another advantageous embodiment of the dental mixing device according to the invention. The dental mixing device 10 uses a first cartridge 20, 20′ that is a unit-dose package and has a first volume between 20 ml and 60 ml. The second cartridge 30, though, is not provided in the form of a unit-dose package, but rather as a bulk package and has a second volume between 100 ml and 500 ml. Advantageously, the second cartridge 30 is used as a reservoir for a universal activator component that can react with different base components, each of which is stored in adapted first cartridges 20, 20′. To prepare the multi-component material 11 by mixing, a first cartridge 20 is introduced into the first storage site 22 and squeezed out by the motorized advancer 50 or a different unit. The component stored in the first cartridge 20 flows via the first feed line 21 into the mixer 40. Another component—advantageously, this would be the activator component—flows from the second cartridge 30 via the second feed line 31 into the mixer 40. The two components are then stirred inside the mixer 40, such that the multi-component material 11 is formed.

In the exemplary embodiment shown, the mixer 40 is provided such as to be replaceable. For this purpose, quick-release fasteners 41 are arranged on the mixer 40, and each facilitates connection of the mixer 40 to the first feed line 21 and the second feed line 31. The quick-release fasteners can be non-positive- and/or positive fit-type connectors that enable reversible installation of the mixer 40 on the dental mixing device 10.

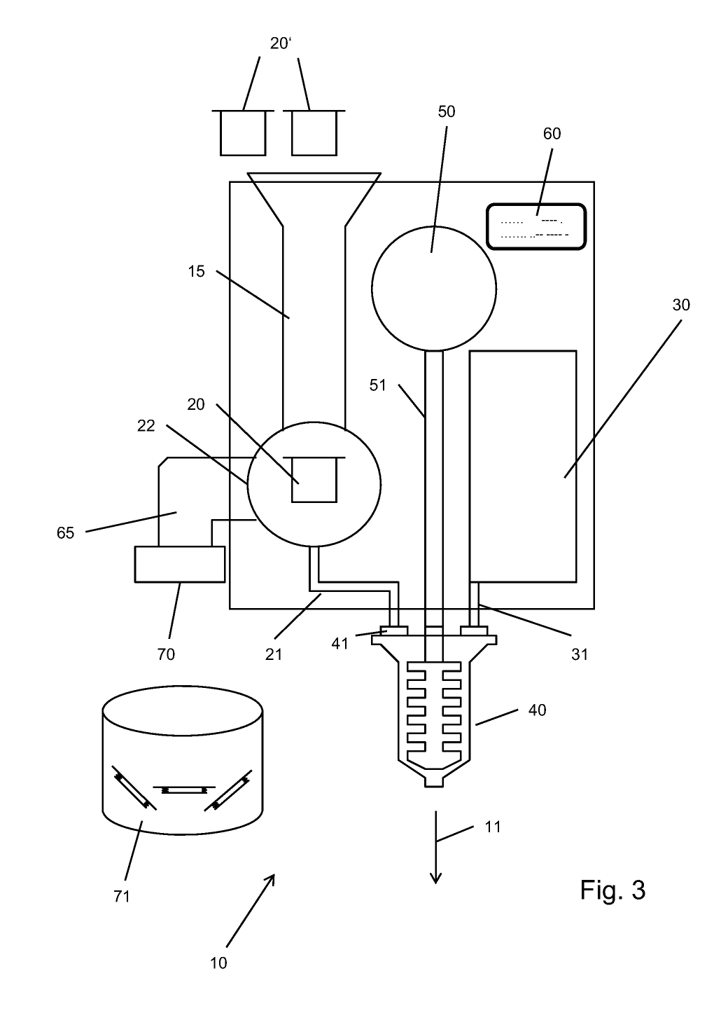

FIG. 3 shows another advantageous embodiment of the dental mixing device 10. Unlike the dental mixing device 10 shown in FIG. 2, this dental mixing device 10 comprises a display 60. In the exemplary embodiment shown, the display 60 is a touchscreen by which information can be entered into the dental mixing device. Moreover, the display 60 displays settings and status information of the dental mixing device 10.

Moreover, the dental mixing device 10 shown in FIG. 3 comprises a compression unit 70. The compression unit serves for ejection of the first cartridge 20 from the first storage site 22, and compression of the first cartridge 20. It is envisioned for this purpose to provide the compression unit with a corresponding mechanical system for ejection of the first cartridge 20 from the first storage site 22 through the ejection opening 65. In addition or by itself, the compression unit 70 may also serve for compression of the first cartridge 20. This is advantageous in that the squeezed out and compressed first cartridges 20 occupy less space in a waste basket 71. Accordingly, easier disposal of the spent first cartridges 20, 20′ would be facilitated by this means.

The dental mixing device 10 can be distinctly smaller than previous dental mixing devices that store large bulk cartridges for multiple applications. If the dentist uses various consistencies, the bulk cartridges in the mixing device need to be replaced, which each time requires a matching of the components. This time requirement and contamination are obviated by the unit-dose package 20, 30. The use of a universal activator component, which is kept in the dental mixing device 10 as a reservoir, simplifies the stock-keeping. By varying the dosing of the activator component, the user can adapt the processing time individually to suit the existing needs, such as is feasible with hand-dosed condensation-crosslinking silicones also. In addition, the dental mixing device 10 ensures reproducible, exact dosing and optimal mixing. The dental mixing device 10 provides the dentist with the option to be able to vary different consistencies and the processing time individually, without time-consuming replacement processes on the dental mixing device 10, such as is the case with condensation-crosslinking silicone impression materials whose components are supplied separately in tubes, cans or bottles and can be dosed individually by the user. The dental mixing device 10 has a small design size, so as to take up as little space as possible in the dental office.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A dental mixing device (10) for generating a multi-component material (11) by squeezing out and mixing the components of the multi-component material (11), the device (10) comprising:
a first cartridge (20, 20′) and a second cartridge (30, 30′) are arranged in the dental mixing device (10) so as to be replaceable;
a first feed line (21) and a second feed line (31) for guiding the components respectively from the first cartridge (20, 20′) and the second cartridge (30, 30′) into a mixer (40); and
a motorized advancer (50) for squeezing the components from the first (20, 20′) and the second (30, 30′) cartridges;
wherein the first cartridge (20, 20′) is a unit-dose package and has a first volume between 20 ml and 60 ml.

2. The dental mixing device (10) according to claim 1, wherein the second cartridge (30, 30′) is a unit-dose package and has a second volume between 5 ml and 30 ml.

3. The dental mixing device (10) according to claim 1, wherein the second cartridge (30, 30′) has a second volume between 350 ml and 400 ml.

4. The dental mixing device (10) according to claim 1, wherein the first cartridge (20, 20′) stores a base component and the second cartridge (30, 30′) stores an activator component.

5. The dental mixing device (10) according to claim 1, wherein the advancer (50) comprises a first and/or a second plunger for squeezing the components respectively from the first (20, 20′) and/or the second (30, 30′) cartridges.

6. The dental mixing device (10) according to claim 1, wherein the advancer (50) comprises at least one electrical motor.

7. The dental mixing device (10) according to claim 1, further comprising a magazine (15) for storing a plurality of the first cartridges (20, 20′).

8. The dental mixing device (10) according to claim 1, further comprising a computer unit for monitoring and/or controlling a squeezing out of the components from the first (20, 20′) and/or the second (30, 30′) cartridge.

9. The dental mixing device (10) according to claim 1, wherein the mixer (40) is designed so as to be replaceable.

10. The dental mixing device (10) according to claim 1, further comprising a compression unit (70) for compressing or ejecting the first (20, 20′) and/or the second (30, 30′) cartridges after the component(s) are squeezed out.

11. The dental mixing device (10) according to claim 1, further comprise a display (60).

12. The dental mixing device (10) according to claim 11, wherein the display (60) comprises a touchscreen.

13. The dental mixing device (10) according to claim 1, further comprising an interface to a central computer unit.
